(19) United States
(12) Patent Application Publication
(10) Pub. No.: US 2012/0284052 A1
(43) Pub. Date: Nov. 8, 2012

(54) SYSTEMS AND METHODS FOR PROVIDING A COMPREHENSIVE INITIAL ASSESSMENT FOR WORKERS COMPENSATION CASES

(76) Inventors: Sandra Lombardi Saukas, Apopka, FL (US); Deborah Anne Spring, Seffner, FL (US); Heather Leigh Chickonoski, Lakeland, FL (US); Natalie Marie Rivera, Zephurhills, FL (US); Jean Marie Chambers, Lakeland, FL (US)

(21) Appl. No.: 13/458,314

(22) Filed: Apr. 27, 2012

Related U.S. Application Data
(60) Provisional application No. 61/480,733, filed on Apr. 29, 2011.

(51) Int. Cl. G06Q 50/24

(52) U.S. Cl. 705/3

(57) ABSTRACT

The CIA (Comprehensive Initial Assessment) tool provides a detailed initial assessment to tell the user of the tool what interaction is needed from the beginning of the injury. The CIA tool uses an innovative predictive scoring methodology to provide predictors on the risk of the clinical outcome of a worker's compensation claim. The CIA tool will help the nurse to manage the claim better as the tool includes specialty assessments to determine longer deviation and outcome of the claim. The CIA tool generates and provides a detailed blue print for case management and summary forms may be provided to the adjuster and/or case manager.

### RELATED APPLICATION

This application claims the benefit of and priority to U.S. Provisional Application No. 61/480,733, entitled “Systems and Methods for Providing a Comprehensive Initial Assessment For Workers Compensation Cases” and filed on Apr. 29, 2011, which is incorporated herein by reference in its entirety for all purposes.

### FIELD OF THE INVENTION

The disclosure generally relates to tools for the assessment of injuries, in particular to providing a tool to perform a comprehensive initial assessment that generates a predictive score of an outcome risk from the injury.

### BACKGROUND

Case management of a worker's compensation claim can be challenging. There are many variables that impact the outcome of the case. The type of injury and the type of work as well as the inherent nature or makeup of the injured work may all impact when the worker may recover from the injury and return to work. Synthesizing all the variables to efficiently and effectively manage and determine the best route for handling the case may be difficult. Furthermore, the cost of changing routes later in the case can be more expensive and may affect whether or not the injured worker eventually returns to work.

### SUMMARY OF THE INVENTION

The CIA (Comprehensive Initial Assessment) tool provides a detailed initial assessment to tell the user of the tool what interaction is needed from the beginning of the injury. The CIA tool uses an innovative predictive scoring methodology to provide predictors on the risk of the clinical outcome of a worker's compensation claim. The CIA tool will help the nurse to manage the claim better as the tool includes specialty assessments to determine longer deviation and outcome of the claim. The CIA tool generates and provides a detailed blue print for case management and summary forms may be provided to the adjuster and/or case manager.

The present solution provides an innovative CIA tool that assists claims handling personnel with projecting the clinical outcome of a workers' compensation claim. The CIA tool may be used as part of the Emergency Management Institute (EMI), Trainable Mentally Impaired (TMI) or Physician Practice Management (PPM) models or utilized as a stand-alone service. The CIA tool is an evolution from extensive data collection to biopsychosocial assessment. The CIA tool applies deductive reasoning to subjective information to provide a “blue print” of anticipated medical and return to work (RTW) progression based on evidence-based guidelines specific to that condition.

The CIA tool may incorporate and leverage multiple industry accepted evaluations to provide an assessment, the predictors and the detailed blue print. The CIA tool may include any combination of the following evaluations: pain assessment, condition specific evaluation tools and psychosocial evaluation tools. The CIA tool assesses and analyzes the injured work to assess and provide any combination of the following information:
Injury mechanism—diagnosis correlates with injury event
Risk factors—potentially preventing a normal process in recovery
Health conditions—physical and psychological, medications, prior injuries
Employment—physical demands of job, Return to Work expectation, employer relationships
Treatment—provider match to injured associate, customize treatment approach based on risk factors, realistic expectations

The CIA tool of present solution offers a plurality of benefits, including but not limited to:
Resulting content is specific to the injured associate and body part
Concise information to the claims handler on the expected medical recovery path
Efficiently manage loss time days and medical costs
Reduce the lag time associated with claim direction
Avoid medical only claims becoming lost time claims
Clearly defined return to work benchmarks
Identify “at risk” injured workers at the onset of the claim based on psychosocial factors which impact recovery expectations and work return.
Inclusion of psycho-social tools for claim management
Subsequent use of tools that are effective to objectively quantitative percent improvement from baseline with treatment rendered and share with provider to rethink treatment course when improvement is minimal.

The CIA tool provides various reports to assist claims handling personnel with projecting the clinical outcome of a workers' compensation claim. The CIA tool provides:
Actionable analytics that allow data to drive decision making
Client-specific data utilized to develop and sustain best in class solutions and superior results
Performance measurements defined
Coordination of networks and certified managed care plans to maximize benefits
Ongoing evaluation of new partners/services as appropriate
Require reporting abilities to validate the CIA tool's predictive scoring methodology which takes the “risk score” of several industry validated predictor tools and combines the total of “risk factors” or “red flags” to determine the predictive risk score and planned level of intervention based on program design.
Future ability to analyze CIA tool's predictive scoring methodology will determine which assessment tools and criteria most accurately predict claims at risk and make additional revisions

In an example embodiments, the CIA tool may provide a CIA report, blue-print and predictive scoring as follows:

### Predictor Level: Risk

Based on the predictor scoring outcome, the injured worker currently exhibits risk behaviors which will prolong the case and return to work unless there is interaction with the injured worker to change the pattern.
The significant findings are the injured worker's recovery expectation and his ability to return to work and to his pre-injury position. The concern expressed by the injured worker and shown through questions is a fear of returning to the same job which may not be the right fit for him and his ability to safely return to work complicates a successful return to work plan.

### Work Return

Job demand and job dissatisfaction will lengthen the time out of work. The average modified duty time is estimated to be up to four (4) weeks for a cervical strain diagnosis and heavy job demand. The likelihood of the injured worker meeting this milestone is low. With coaching and Education, a realistic goal of full duty return within eight (8) weeks is estimated. Provider and/or therapist can explore with the injured worker his reluctance for return to work to allow them to incorporate into the treatment and/or therapy plan. This may include a call between the injured worker's manager and therapist and/or the same with the claims adjuster and manager to inform and educate for when injured worker returns to work. The possibility exists for an onsite assessment of the work demands by therapist to determine if this is a right fits for the injured worker with the intent of preventing further injuries costing all more time and money.

In some aspects, the present solution is directed to a method for generating a clinical outcome risk of a worker's compensation claim. The method includes identifying, via a tool executing on a device, a score for each of a plurality of assessments performed on a patient in connection with a worker's compensation claim of the patient. Via the tool, a risk factor for each score of each of the plurality of assessments is determined and based on this determination, an outcome risk for a clinical outcome of the worker's compensation claim is generated.

In some embodiments, the method includes identifying a single score for an assessment of the plurality of assessments that provides a range of scores. In some embodiments, the method includes identifying the score for the plurality of assessments comprising two or more of the following: a specialty assessment, a standard Fear Avoidance Benefits Questionnaire (FABQ) assessment, a standard Behavioral Pain Score (BPS) assessment and a biopsychosocial assessment. In some embodiments, the method includes identifying one or more scores for a biopsychosocial assessment comprising one or more of the following assessments: pain perception, job demand and job satisfaction.

In some embodiments, the method includes determining, by the tool, the risk factor for an assessment of the plurality of assessments based on the score resulting from performance of the assessment of the patient being below or above a predetermined threshold. In some embodiments, the method includes determining, by the tool, the risk factor comprising one of the following: risk, at risk and normal. In some embodiments, the method includes generating, by the tool, the outcome risk based on a combination of risk factors corresponding to each score of the plurality of assessments. In some embodiments, the method includes generating, by the tool, the outcome risk comprising a single outcome predictor of the worker's compensation claim.

In some embodiments, the method includes generating a blueprint comprising a summary of an overall assessment and at least one of the following: medical related progression and return-to-work (RTW) progression. In some embodiments, the method includes generating a blueprint comprising one of a medical intervention blueprint or a biopsychosocial blueprint.

In some aspects, the present solution is directed to a system for generating a clinical outcome risk of a worker's compensation claim. The system may include a tool, such as embodiments of the CIA tool described herein, executing on a device. The tool may identify a score for each of a plurality of assessments performed on a patient in connection with a worker's compensation claim of the patient. A predictive scorer of the tool may determine a risk factor for each score of each of the plurality of assessments and based on the determination may generate an outcome risk for a clinical outcome of the worker's compensation claim.

In some embodiments, the tool identifies a single score for an assessment of the plurality of assessments that provides a range of scores. In some embodiments, the tool identifies the score for the plurality of assessments comprising two or more of the following: a specialty assessment, a standard Fear Avoidance Benefits Questionnaire (FABQ) assessment, a standard Behavioral Pain Score (BPS) assessment and a biopsychosocial assessment. In some embodiments, the tool identifies one or more scores for a biopsychosocial assessment comprising one or more of the following assessments: pain perception, job demand and job satisfaction. In some embodiments, the predictive scorer determines the risk factor for an assessment of the plurality of assessments based on the score resulting from performance of the assessment of the patient being below or above a predetermined threshold. In some embodiments, the predictive scorer determines the risk factor comprising one of the following: risk, at risk and normal. In some embodiments, the predictive scorer generates the outcome risk based on a combination of risk factors corresponding to each score of the plurality of assessments. In some embodiments the predictive scorer generates the outcome risk comprising a single outcome predictor of the worker's compensation claim.

In some embodiments the tool generates a blueprint comprising a summary of an overall assessment and at least one of the following: medical related progression and return-to-work (RTW) progression. In some embodiments the tool generates a blueprint comprising one of a medical intervention blueprint or a biopsychosocial blueprint.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein.

FIG. 1D is a block diagram that depicts one embodiment of a system for providing comprehensive initial assessment for injuries.

FIG. 2A is a flow diagram that depicts an overview of one embodiment of system for providing comprehensive initial assessment for injuries.

FIG. 2B-2F are flow diagrams of embodiments of methods for providing comprehensive initial assessments for injuries.

FIG. 3A-3O are diagrams depicting interfaces for providing comprehensive initial assessment for injuries.

FIG. 4 is a flow diagram of an embodiment of a method for generating an outcome risk for a worker's compensation claim.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network and computing environment which may be useful for practicing embodiments described herein; and
Section B describes embodiments of systems and methods for providing a comprehensive initial assessment for injuries.

### A. System and Network Environment

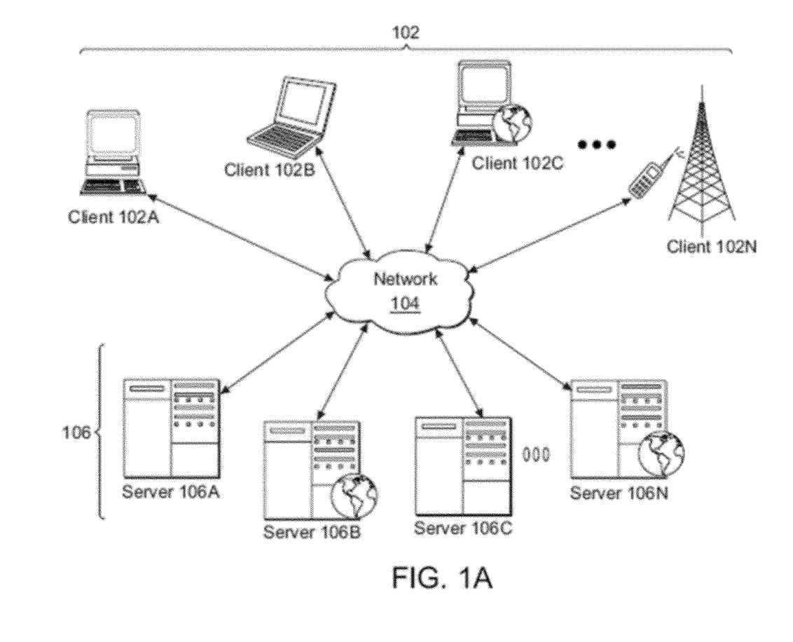

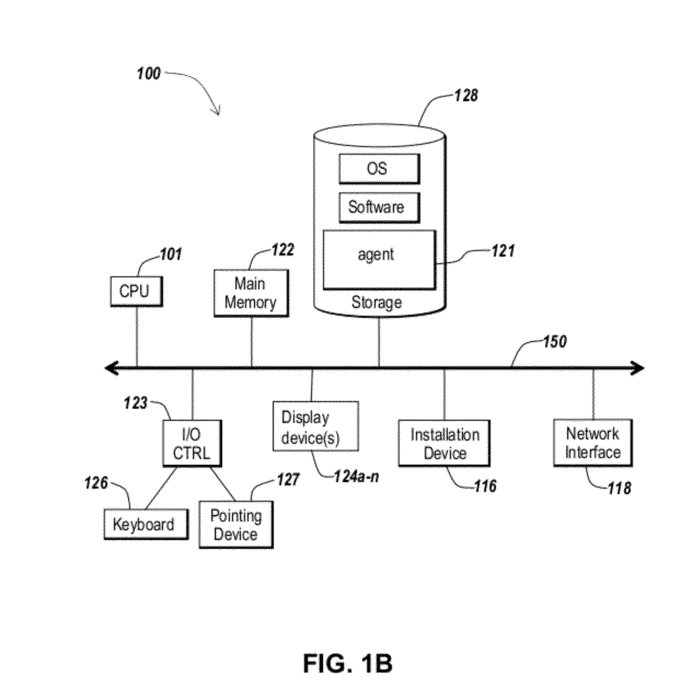

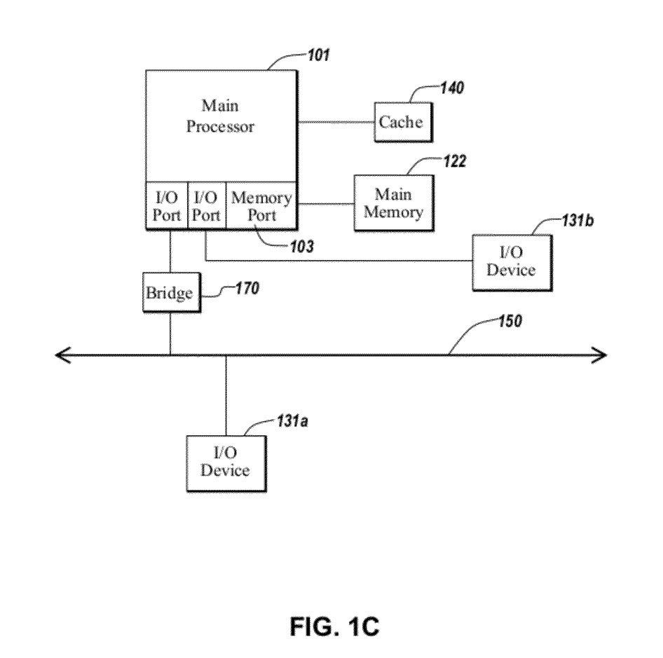

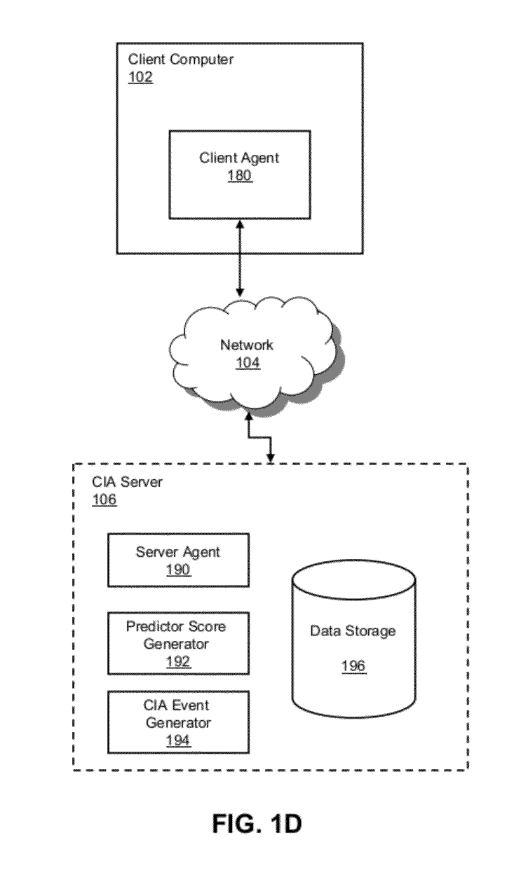

Prior to discussing specific embodiments of the present solution, it may be helpful to describe aspects of the operating environment as well as associated system components (e.g., hardware elements) in connection with the methods and systems described herein. FIG. 1A illustrates one embodiment of a computing environment that includes one or more client machines 102A-102N (generally referred to herein as “client machine(s) 102”) in communication with one or more servers 106A-106N (generally referred to herein as “server(s) 106”). Installed in between the client machine(s) 102 and server(s) 106 is a network.

The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

In one embodiment, the client machine 102 can be a virtual machine 102C. The virtual machine 102C can be any virtual machine, while in some embodiments the virtual machine 102C can be any virtual machine managed by a hypervisor developed by IBM, VMware, or any other hypervisor. In other embodiments, the virtual machine 102C can be managed by any hypervisor, while in still other embodiments, the virtual machine 102C can be managed by a hypervisor executing on a server 106 or a hypervisor executing on a client 102.

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The computing environment can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS NT, manufactured by Microsoft Corp. of Redmond, Wash., UNIX, LINUX, or SNOW LEOPARD.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS). Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can connect to multiple display devices 124A-124N, in other embodiments the computing device 100 can connect to a single display device 124, while in still other embodiments the computing device 100 connects to display devices 124A-124N that are the same type or form of display, or to display devices that are different types or forms. Embodiments of the display devices 124A-124N can be supported and enabled by the following: one or multiple I/O devices 130A-130N; the I/O controller 123; a combination of I/O device(s) 130A-130N and the I/O controller 123; any combination of hardware and software able to support a display device 124A-124N; any type and/or form of video adapter, video card, driver, and/or library to interface, communicate, connect or otherwise use the display devices 124A-124N. The computing device 100 may in some embodiments be configured to use one or multiple display devices 124A-124N, these configurations include: having multiple connectors to interface to multiple display devices 124A-124N; having multiple video adapters, with each video adapter connected to one or more of the display devices 124A-124N; having an operating system configured to support multiple displays 124A-124N; using circuits and software included within the computing device 100 to connect to and use multiple display devices 124A-124N; and executing software on the main computing device 100 and multiple secondary computing devices to enable the main computing device 100 to use a secondary computing device's display as a display device 124A-124N for the main computing device 100. Still other embodiments of the computing device 100 may include multiple display devices 124A-124N provided by multiple secondary computing devices and connected to the main computing device 100 via a network.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; and WINDOWS VISTA; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device.

FIG. 1D illustrates one example architecture of a system for providing comprehensive initial assessment (CIA) for injuries. As illustrated, the system includes a client agent 180 executing on a client computer 102. The client agent 180 is in communication with a CIA Server 106. The CIA Server 106 includes a server agent 190, a predictor score generator 192, a CIA event generator 194 and data storage 196. The client agent 180, server agent 190, predictor score generator 192, and CIA event generator 194 may include a software or firmware instruction that can be stored within a tangible computer readable medium (e.g. magnetic disk drive, optical disk or solid state memory such as flash memory, or random-access memory) and executed by a processor or equivalent electrical circuits, state machines, microcode, or the like.

The client agent 180 displays interfaces to the user and receives data from the user. In some embodiments, the data is collected from multiple interfaces and temporarily stored on the client computer 102 until all necessary data is collected. In some embodiments, the data is immediately transmitted over the network to the server agent 190 as soon as the information is received from the user. In some embodiments, the data is transmitted to the server agent 190 by the client agent 180 periodically, at pre-determined intervals of time.

The data storage 196 stores reference data received from the client agent 180 and may include client or patient contact information, medical history, symptoms, and other medical or personal information. The data storage 196 may be a relational database or any other type of database that stores the data, such as a flat file. In one embodiment, the data storage 196 is a web enabled reference database supporting remote calls through the Internet to the data storage 196.

The components of the CIA server 106 can reside on a single computer system or several computer systems located close by or remotely from each other. For example, the server agent 190 and the predictor score generator 192 may reside on separate servers, and the data storage 196 may be located in a dedicated database server. In addition, any of the components or sub-components may be executed in one or multiple computer systems.

The CIA server 106 may include any type or form of hardware and/or combination of hardware and software. The CIA server 106 may include any application, program, library, script, process, task, thread or any type and form of executable instructions that executes on any processor or core of the system. The CIA server 106 may include one or more modules including a server agent 190, a predictor score generator 192, and a CIA event generator 194. Any one or more of these modules may have or inherit some attributes of the CIA server 106. Any one or more of these modules may comprise some portion of the CIA server 106, e.g., the hardware or combination of hardware and/or software.

The CIA server 106 may include a server agent 190 for receiving data and/or transmitting the data to a destination (e.g., client 102). The CIA server 106 may receive data from a plurality of devices, and may process data between any two or more devices in either direction (i.e., provides bidirectional support). The CIA server 106 may be designed, constructed and/or configured to receive, intercept, re-direct, reroute, filter or otherwise process the data.

The server agent 190 may be designed, constructed and/or configured to extract, parse, infer, identify or otherwise process data or any content that may be received from another computing device. The server agent 190 may comprise hardware or any combination of software and hardware. The server agent 190 may include an application, program, library, script, process, task, thread or any type and form of executable instructions that executes on one or more processors or cores of the computer. In some embodiments, the server agent 190 may decrypt, uncompress, perform protocol translation or otherwise process received data.

The predictor score generator 192, generally or also referred to as a predictive scorer, may comprise hardware or any combination of software and hardware. In some embodiments, the predictor score generator 192 may be a component of the CIA server 106. In some embodiments, the predictor score generator 192 may include any application, program, library, script, process, task, thread or any type and form of executable instructions that executes on any processor or core of the system. The predictor score generator 192 may be in communication with the server agent 190, CIA event generator 194, and the data storage 196. In some embodiments, the predictor score generator 192 may receive data parsed by the server agent 190. The predictor score generator 192 may communicate data to the CIA event generator 194 to generate a CIA event responsive to the predictor score 192. The predictor score generator 192 may process the data to generate a predictor score or predictor score range. The predictor score generator 192 may place the predictor score in data storage 196, or encrypt or decrypt the score and transmit it to the client agent 180. In some embodiments, the predictor score generator 192 may perform any of the functions described herein responsive to a policy, action, or rule of the server 106.

The CIA event generator 194 may be designed, constructed and/or configured to modify, update, generate, identify, or otherwise process a CIA event. The predictor score generator 192 may comprise hardware or any combination of software and hardware. The predictor score generator 192 may include an application, program, library, script, process, task, thread or any type and form of executable instructions that executes on one or more processors or cores of the system. In other embodiments, the predictor score generator 192 is designed and constructed to process or generate a CIA event to be used by the system.

### B. Systems and Methods for Providing a Comprehensive Initial Assessment for Injuries

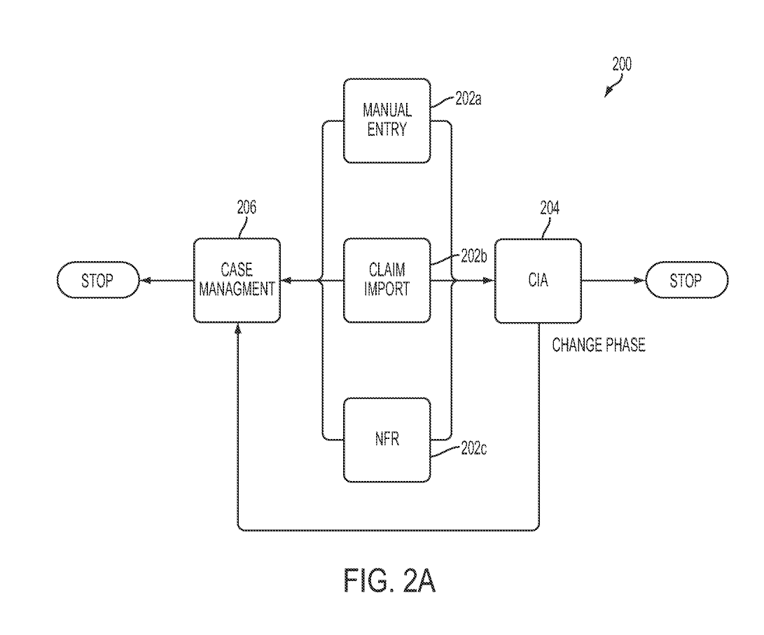

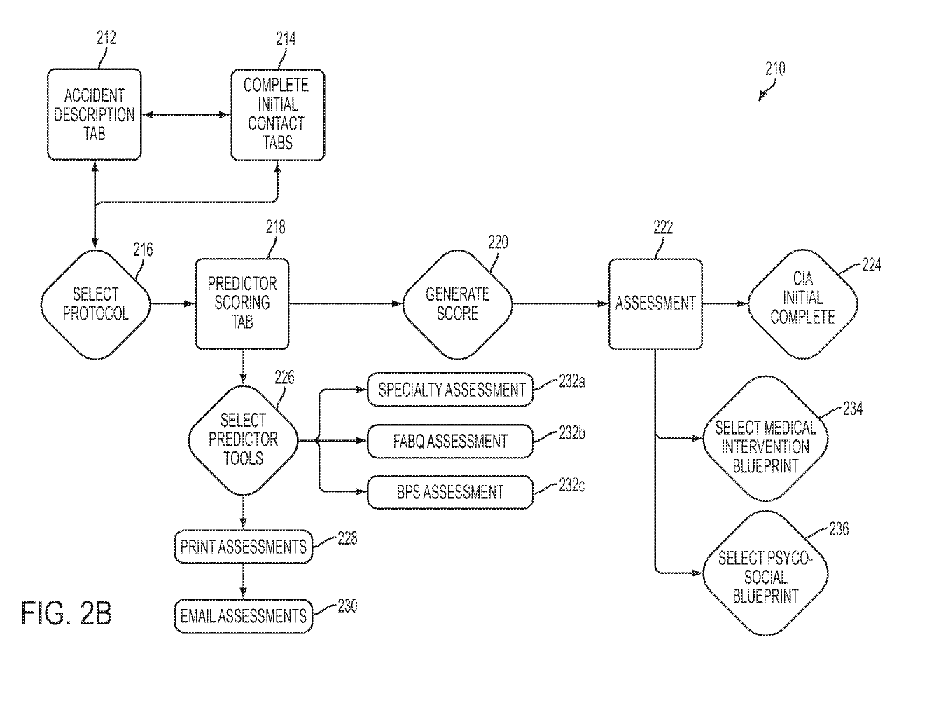

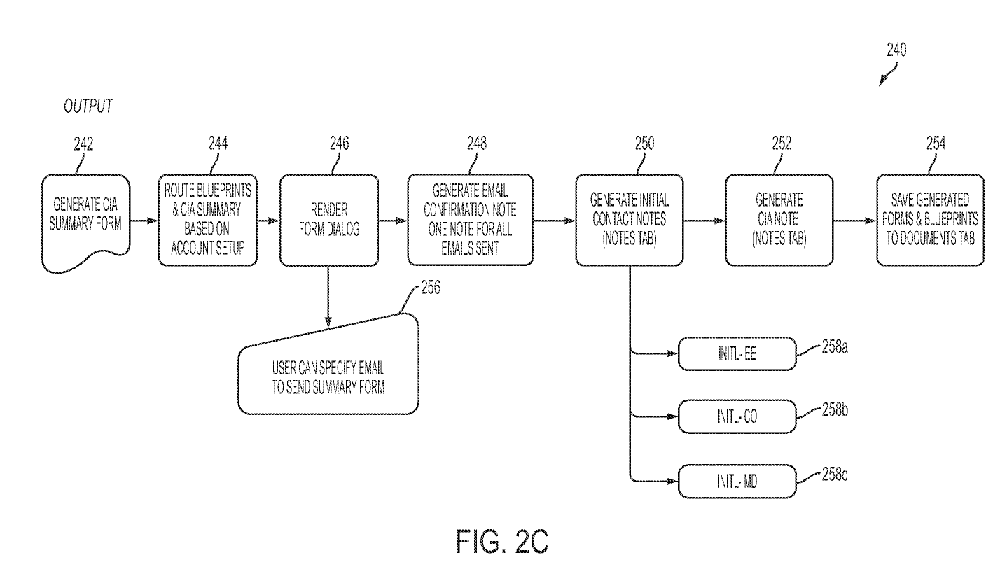

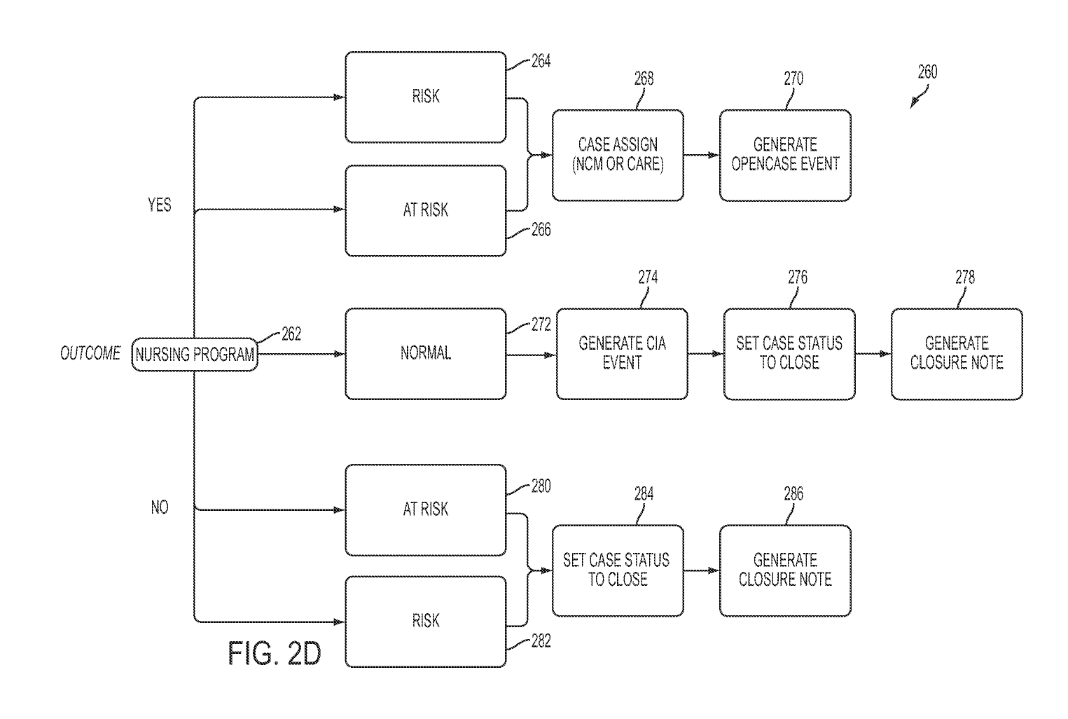

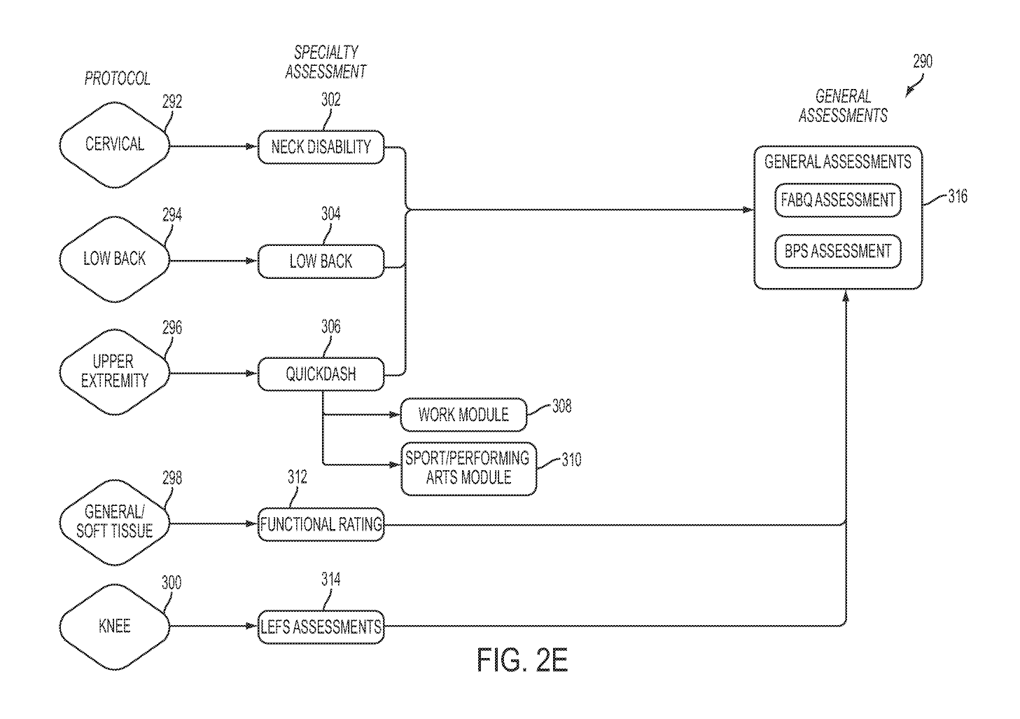

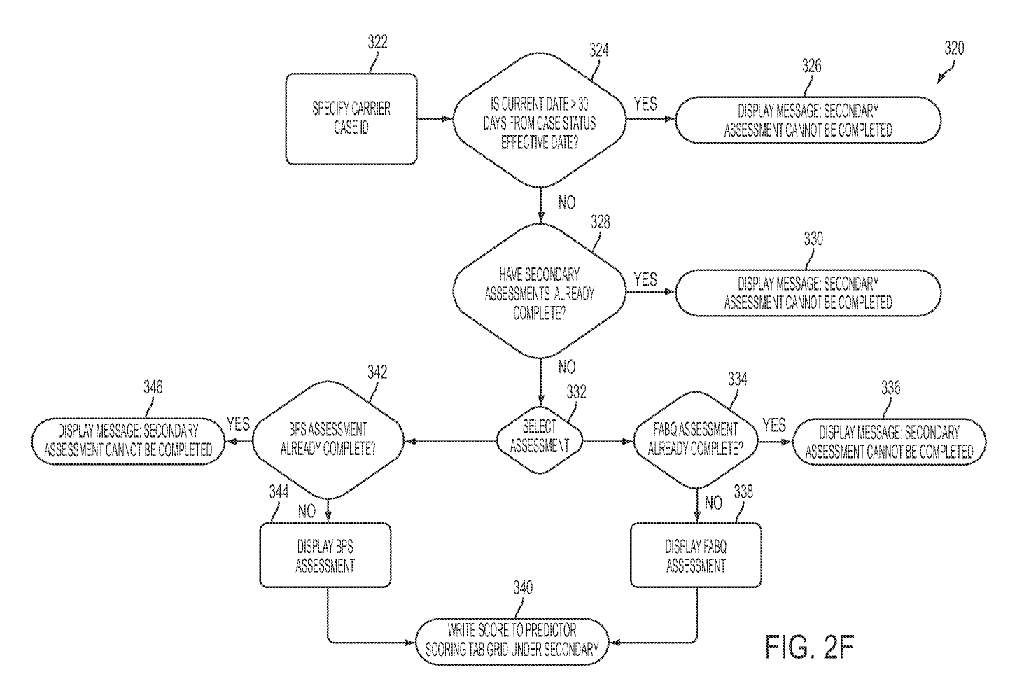

FIG. 2A is a flow diagram depicting the overall flow for providing a comprehensive initial assessment for injuries. In brief overview, the method 200 depicted includes importing information at step 202. At step 204, the system performs a comprehensive initial assessment (CIA). Once, the CIA is complete, then the method terminates. If there is a change phase, then at step 206, changes are made in the case management. Once the change phase is complete, the method terminates.

Now referring to FIG. 2A, in more detail, at step 202, many different kinds of data are entered into the system. Types of data entered into the system include patient or client information, employee or practitioner information, information related to the institution where the client or patient is treated, billing information, including but not limited to credit card information and health insurance information, medical history and symptoms. At step 202a, the data entered into the system is entered manually. In some embodiments, this may include manually typing in all the different types of information, scanning information into the system, utilizing user interfaces to enter data into the system, and audio dictation or capture of information. At step 202b, data may be entered into the system through claim import. In some embodiments, a claim may be generated using a different system. In some embodiments, the claim may be generated using an earlier version of the CIA system. In some embodiments, the claim may be generated using any of systems related to the CIA system. In some embodiments, the claim may be generated using the CIA system. At step 202c, data may be entered using the No Further Remediation (NFR) form, such as to generate NFR related communications.

At step 204, after the data has been entered into the system, and the information requires further analysis, the CIA system performs a comprehensive initial assessment using the received data. In some embodiments, after the data has been entered into the system, the information does not require any further analysis, then the user is directed to the case management tools. In some embodiments, the totality of data collected and entered is used to create an initial assessment. In some embodiments, some of the data collected and entered is used to create an initial assessment. In some embodiments, the comprehensive initial assessment may be given as a range or percentage of risk. In some embodiments, to determine the range or percentage of risk, the CIA uses a predictor scoring feature generated by the predictor score generator 192, as described herein.

If, at step 204, a phase change is necessary, then at step 206, the phase can be changed using the case management tools. In some embodiments, the case management tools permit a user to correct any data entered or modify or change the entered or collected data.

FIG. 2B is a flow diagram depicting the flow for entering data prior to the assessment for injuries. In brief overview, the method 210 includes starting at the Accident Description Tab (ADT) 212. From the ADT, the user may complete the Initial Contact Tabs 214. At 216, the user may select an available protocol. At 218, the user is presented with the Predictor Scoring Tab. At 226, the user may select Predictor Tools. The Predictor Tools include Specialty Assessment 232a, FABQ Assessment 232b, and BPS Assessment 232c. From the Predictor Tools 226, a user can print the assessments 228 and email the assessments 230. From the Predictor Score Tab 218, the user can generate a score 220. The score generated at 220 is used at 222 during the Assessment. During the Assessment, at 234, the user can select a Medical Intervention Blueprint or at 236, select a BioPsychoSocial Blueprint. Once the Assessment is complete, the CIA Initial input is complete at 224. In some embodiments, each protocol can have more than one Medical Intervention Blueprint PDF listed. In some embodiments, the Nursing Program may created the PDF documents and will provide IT with the protocol the PDF document is associated with. For the Psycho-Social Intervention Blueprint document, the outcome generated by the system will determine the documents listed to the user.

Now referring to FIG. 2B, and in more detail, the method 210 includes starting at the Accident Description Tab 212. From the Accident Description Tab, the user may go to 214 and complete the Initial Contact Tabs. In some embodiments, the Initial Contact Tabs, displayed by the client agent 180, display interfaces for the user to enter information about the patient or client and any related personal information. This information may include name, mailing address, home address, phone numbers, emails, pre-existing conditions, emergency contact information, insurance information, and any other type of information that may be related to the client or patient to identify, bill, or analyze the patient or client. In some embodiments, the client agent 180 communicates with the data storage 196 to identify the client or patient and automatically populates the Initial Contact Tab with information retrieved from the data storage 196. In some embodiments, the client agent transmits the received data in the Initial Contact Tab upon completion of the tab at 214 to the data storage 196.

In some embodiments, the user may go to 216 to select a Protocol prior to completing the Initial Contact Tabs. In other embodiments, the user may only go to step 216 if a minimum required amount of data is received. In some embodiments, the user may select a Protocol at 216 and return to 214 to complete the Initial Contact Tab. In some embodiments, the user may go directly to 216 to select an available protocol prior to navigating to the Initial Contact Tab. In some embodiments, a Protocol is set to a defaulted value or protocol and the user may change the protocol at a later time. In some embodiments, the Protocol is selected responsive to the data received at 214 at the Initial Contact Tab. In some embodiments, a user must select a protocol at 216 prior to completing the Initial Contact Tab at 214.

At 218, the user is presented with the Predictor Scoring Tab. In some embodiments, the client agent 180 displays a predictor score generated by the Predictor Score Generator 192 and received from the server agent 190. In some embodiments, the client agent 180 displays a previously generated predictor score retrieved from the data storage 196. At 226, the user may select predictor tools. In some embodiments, the Predictor Tools may include Specialty Assessment 232a, Fear Avoidance Benefits Questionnaire (FABQ) Assessment 232b, and/or Behavioral Pain Score (BPS) or Biopsychosocial Assessment 232c. From the Predictor Tools at 226, a user can print the assessments at 228 and/or email the assessments at 230. In some embodiments, the user can email the assessments to an email associated with the client or patient. In some embodiments, the email is encrypted prior to being sent to preserve privacy of the client or patient. In some embodiments, an email is sent to a recipient with a hyperlink to a location to access the assessment, but the email does not contain any information from or about the assessment.

From the Predictor Score Tab at 218, the user can generate a score 220. In some embodiments, the Predictor Score is generated by the predictor score generator 192. In some embodiments, the predictor score generator generators a preliminary predictor score based upon the available information and adjusts the score as more information is collected, received, or derived.

The score generated at 220 is used at 222 during the assessment. During the assessment, at 234, the user can select a Medical Intervention Blueprint or at 236, select a BioPsychoSocial or PsychoSocial Blueprint. In some embodiments, a blueprint is generated based on the data entered by the user. A blueprint may include a summary of the assessment and anticipated medical and/or Return-to-Work progression based on evidence-based guidelines specific to that condition. In some embodiment, the blueprint may include anticipated time-related milestones, cautionary information, and expected complications or side effects a patient or client may anticipate or should be aware. Once the Assessment is complete, the CIA Initial input is complete at 224.

FIG. 2C is a flow diagram depicting the flow for a method 240 for generating output from the CIA system. In brief overview, at step 242, a CIA Summary form is generated. At step 244, responsive to the preferences in Account Setup, the blueprints (e.g., steps 234 and 236 from FIG. 2B) an the CIA Summary form are routed to a destination. At step 246, a Form Dialog is rendered. At step 256, the user can specify an email address to send the summary form. At step 248, an email is generated and a confirmation Note One note is generated for all emails sent. At step 250, Initial Contact Notes are generated in the Notes Tab. At steps 258a-258c, the Initial Contact Notes may be generated using an existing form. At step 252, a CIA Note is generated. At step 254, the generated forms and blueprints are saved to the Documents Tab.

Now referring to FIG. 2C, and in more detail, a method 240 for generating output from the CIA system is depicted. At 242, CIA Summary form is generated after the CIA Initial is completed in FIG. 2B. In some embodiments, the CIA Summary form is generated by the client agent 180 using the information received from the user. In some embodiments, the CIA Summary form is generated using information retrieved from the data storage 196. In some embodiments, the CIA Summary form is generated by the CIA event generator 194. In some embodiments, the CIA summary is generated automatically responsive to a policy of the system. In some embodiments, the CIA summary is generated responsive to receiving a message that the CIA initial was completed in FIG. 2B.

At step 244, responsive to the preferences in Account Setup, the blueprints (e.g., steps 234 and 236 from FIG. 2B) and the CIA Summary form are routed to a destination. In some embodiments, a user specifies the method of communication to send the Blueprint and/or the CIA summary. A user may specify a program or department to associate with the client or patient in Account Setup. In some embodiments, the user may specify a method of contact for the program or department, such as an email address or website to upload the data. At step 246, a Form Dialog is rendered using the CIA summary. In some embodiments, the Form Dialog may also use the Blueprint and any other information supplied by the user or associated with the client or patient.

At step 256, the user can specify an email address to send the summary form. In some embodiments, the user can specify multiple email addresses. In other embodiments, the user may only specify a single email address. In some embodiments, the user may specify the type of content of the email, such as plain text, rich text, or HTML. In some embodiments, the user may specify to send the CIA summary form to the specified email address. In other embodiments, the user may specify that notifications may be sent to the email recipient, but in order for the recipient to access the information, they must navigate to a web browser or other client agent to access secure, encrypted data.

At step 248, an email is generated and a confirmation note. One note is generated for all emails sent. In some embodiments, the Confirmation Note may not be edited once the email confirmation is generated. In some embodiments, an email is generated each time the confirmation note is edited or modified in any way.

At step 250, Initial Contact Notes are generated and stored in the Notes Tab. In some embodiments, only individuals with proper access may create and modify the Initial Contact Notes. In some embodiments, once an Initial Contact Note is generated at saved in the Notes Tab, it may not be modified. Any subsequent notes may be appended in an associated or related Note and saved to the Notes Tab.

The Initial Contact Notes may be generated using an existing form, such as 258a-258c. An Initial Employee form 258a may collect different types of information. In some embodiments, the Initial Employee form may collect a telephone number of the client or patient, name of the client or patient, the chief complaint of the client or patient and the mechanism or area of injury. The form may also include questions related to the employee's perception of injury on return-to-work (RTW), whether the employee displays catastrophic thinking, such as suicidal thoughts, or thoughts that may severely impair the ability of the client or patient, and the employee's perception of any employment concerns. In some embodiments, the form may include work status, record of last visit, schedule of future visit, notes of treatment that has been provided, pending, or requested and a pain assessment. In some embodiments, the form may include information regarding the client or patient's current employment (contact, position, description of job, duration, and supervisor) and past employment.

An Initial Company form 258b may collect different types of information. The Initial Company form 258b collects data that may include a phone number and contact of the company, a history of the injury (i.e. whether the injury occurred at the workplace), employment data, such as duration, job title, job demand, employment status, and any concurrent employment. In some embodiments, the data may include Employer concerns and whether they were verbalized to the employee. In some embodiments, the data includes data related to the treatment provided, such as the type of treatment, how the provider was selected, and notes related to any pending, requested, or provided treatments. In some embodiments, the data may include the work status of the employee.

An Initial Provider form 258c may collect different types of information. The collected data may include contact information for the client or patient, records of previous visits, schedule of future visits, diagnosis of the client or patient and descriptions and notes of the treatment provided, requested, or pending.

At 252, a CIA Note is generated. In some embodiments, the CIA notes is generated responsive to a policy. In some embodiments, the CIA note is generated responsive to the completion of the Initial Contact Notes. At 254, the generated forms and blueprints are saved to the Documents Tab of the system.

FIG. 2D is a flow diagram depicting the flow for one embodiment of a method 260 using the output generated by the CIA system in FIG. 2C. In brief overview, step 262, for example, the Nursing Program determines that the received data from FIG. 2C requires further analysis. In some embodiments, the Predictor Score is used to determine the level of risk associated with the client or patient. Based on the Predictor Score, if the Nursing Program determines that the client or patient is categorized as RISK or AT RISK and the client or patient will be assigned as a case, then the data is transmitted to step 264 for RISK and step 266 for AT RISK. If the Nursing Program determines that the client falls within the NORMAL category, the data is transmitted to step 272. If the Nursing Program determines that the client or patient is AT RISK or RISK but will not be assigned as a case, then the data will be transmitted to step 280 for AT RISK and step 282 for RISK. From steps 264 and 266, the client or patient is assigned to a case at step 268 and at step 270 an OPENCASE event is generated. From step 272, at step 274, a CIA event is generated and at step 276 the case status of the CIA even is set to CLOSE. At step 278 a CLOSURE note is generated for the patient or client. From steps 280 and 282, at step 284, the case status is set to CLOSE and at step 286 a CLOSURE note is generated.

FIG. 2E is a flow diagram depicting the different protocols that can be specified at the Accident Description Tab from FIG. 2B and their accompanying workflows. In brief overview, generally, a Protocol will identify a specific Specialty Assessment which will then be used by the General Assessments. The Cervical protocol (step 292) will specify the Neck Disability (step 302) which will then be used at step 316 for the General Assessments. The Low Back Protocol (step 294) will specify the Low Back specialty assessment which will then be used at step 316 for the General Assessment. The Upper Extremity Protocol (step 296) will specify the Quick Dash specialty assessment (step 306), which may specify a Work Module 308 or a Sport/Performing Arts Module 310. The results of the modules will then be used at step 316 for the General Assessment. The Genera/Soft Tissue Protocol 298 will specify the Functional Rating 312 which will then be used at step 316 for the General Assessment. The Knee Protocol 300 will specify the LEFS assessments 314 which will then be used at step 316 for the General Assessment.

FIG. 2F is a flow diagram that is invoked if during the CIA Initial, the Specialty Assessment is completed, but the FABQ and BPS assessments were not. The user has the ability to conduct a Secondary Assessment 320 should the injured worker comply. At 322, the carrier case ID is specified. In some embodiments, this ID is generated by the system during the Initial Contact Information gathering. In other embodiments, this ID is generated outside of the system and associated with the client or patient during the collection of data by the user. At 324, a determination is made regarding whether the current date is greater than pre-determined amount of time (for example, 30 days) from the Case Status Effective Date. If the more than the pre-determined amount of time has elapsed, then at step 326, a message is displayed stating that the Secondary Assessment cannot be completed. If the current date is less than the pre-determined amount of time from the Case Status Effective Date, then at 228, a check is performed to determine if a Secondary Assessment has already been performed. If yes, then at step 330, a message is displayed stating that the Secondary Assessment cannot be completed. If No, then at step 332, an assessment is selected, such as the FABQ or BPS Assessments. At step 334, if the FABQ Assessment has been selected, then a check is performed to determine if an FABQ Assessment has already been completed. If Yes, then at 336, a message is displayed stating that the Secondary Assessment cannot be completed. If No, then at step 338, the FABQ Assessment is displayed for the user. If at step 332 the BPS assessment has been selected, then at step 342, then a check is performed to determine if a BPS Assessment has already been completed. If Yes, then at 346, a message is displayed stating that the Secondary Assessment cannot be completed. If No, then at step 344, the BPS Assessment is displayed for the user. From 344 and 338, the score generated from the respective assessments are stored to the Predictor Scoring Tab grid.

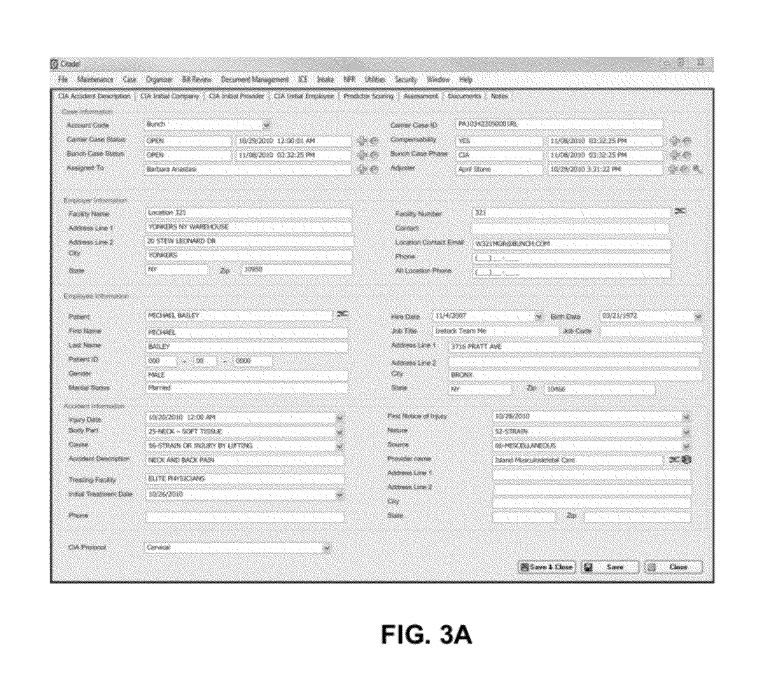

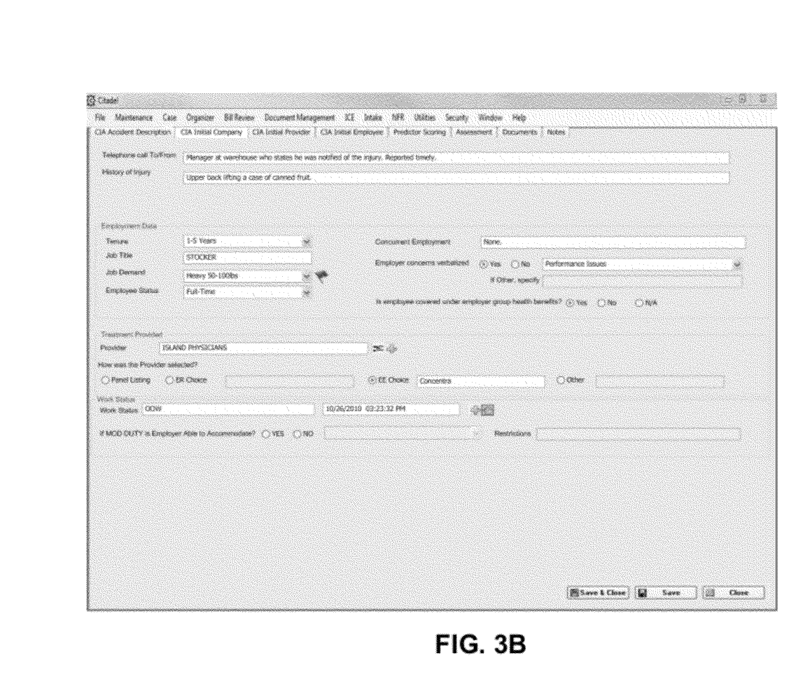

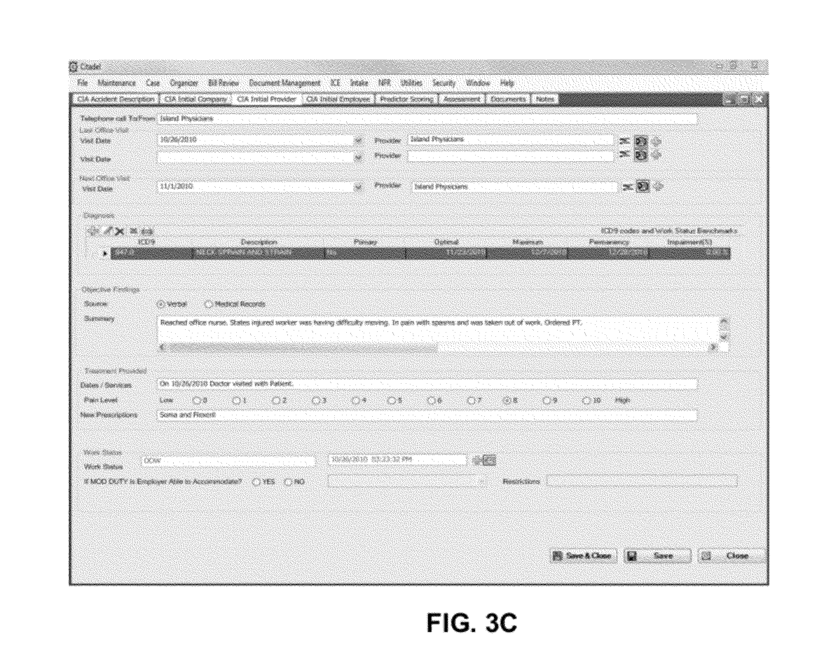

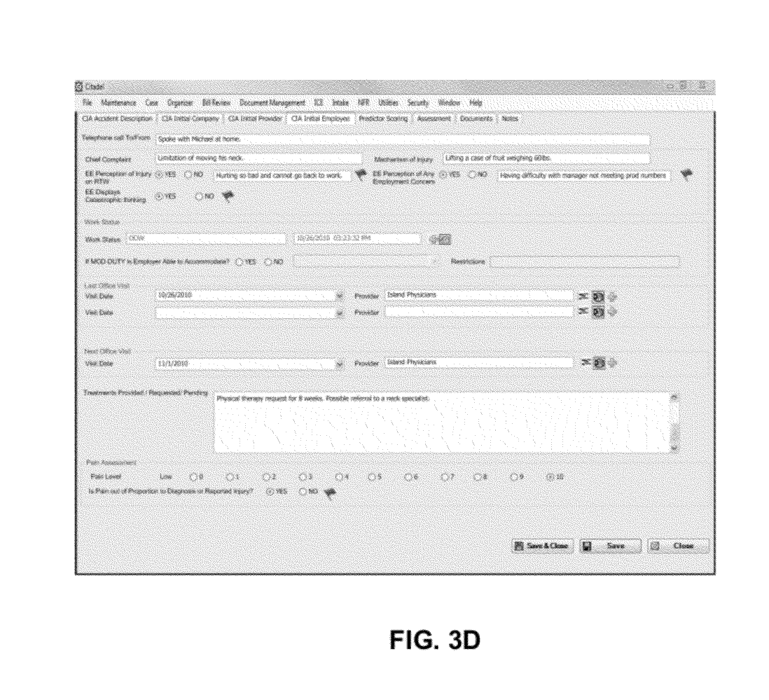

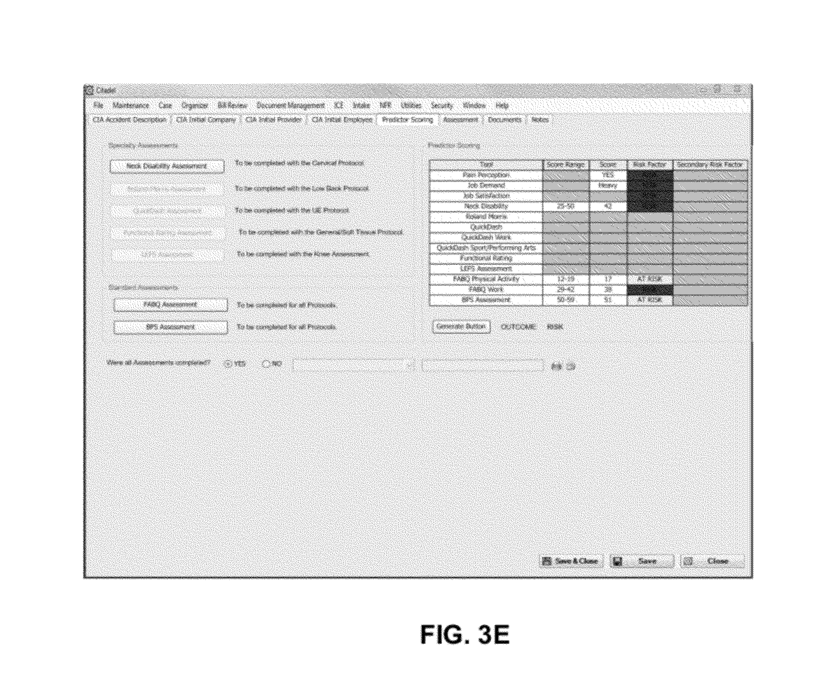

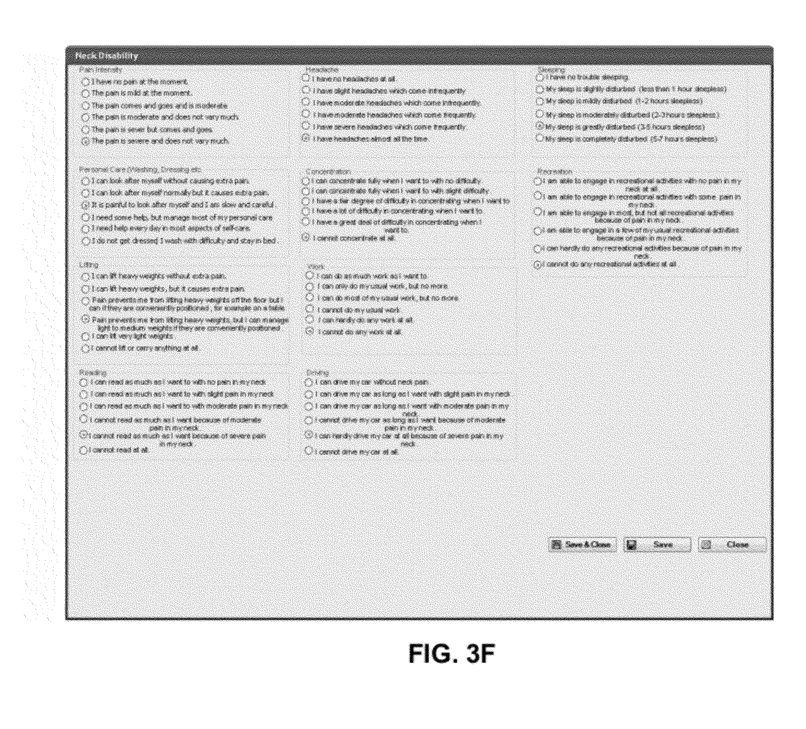

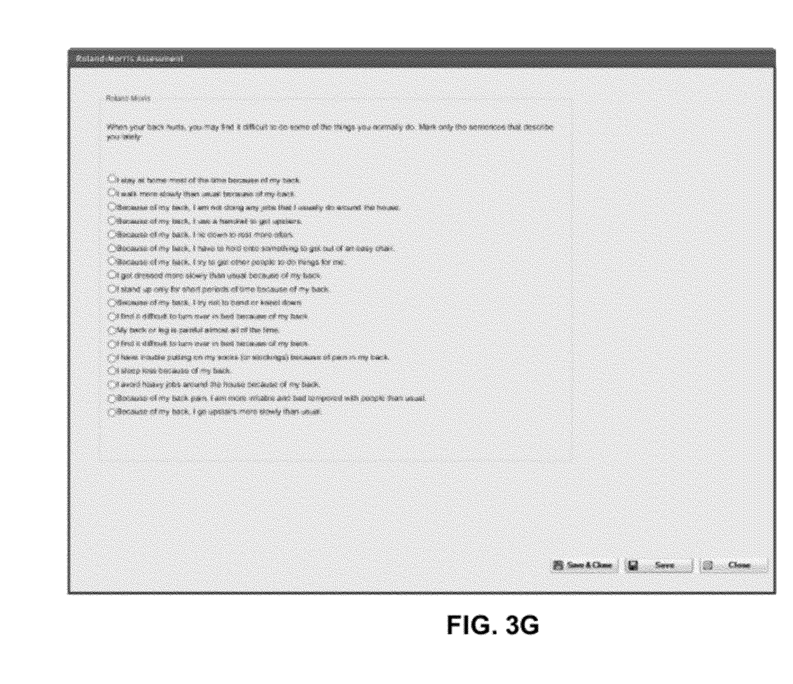

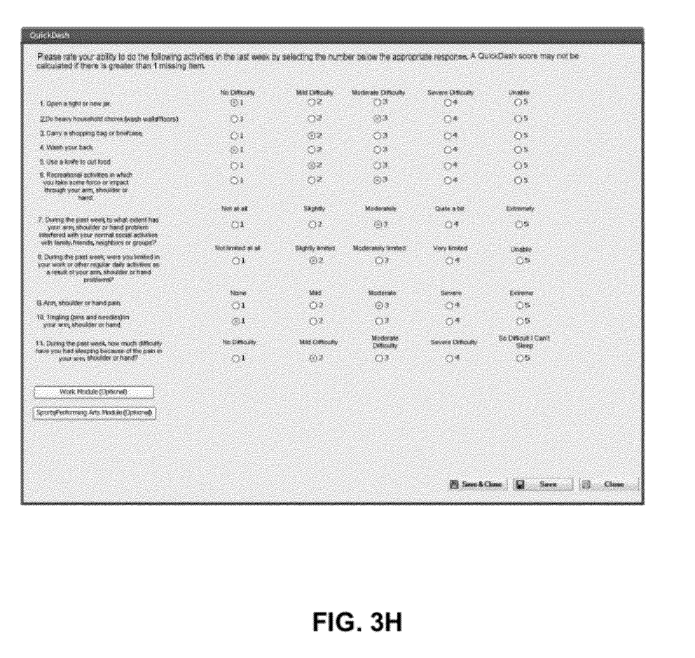

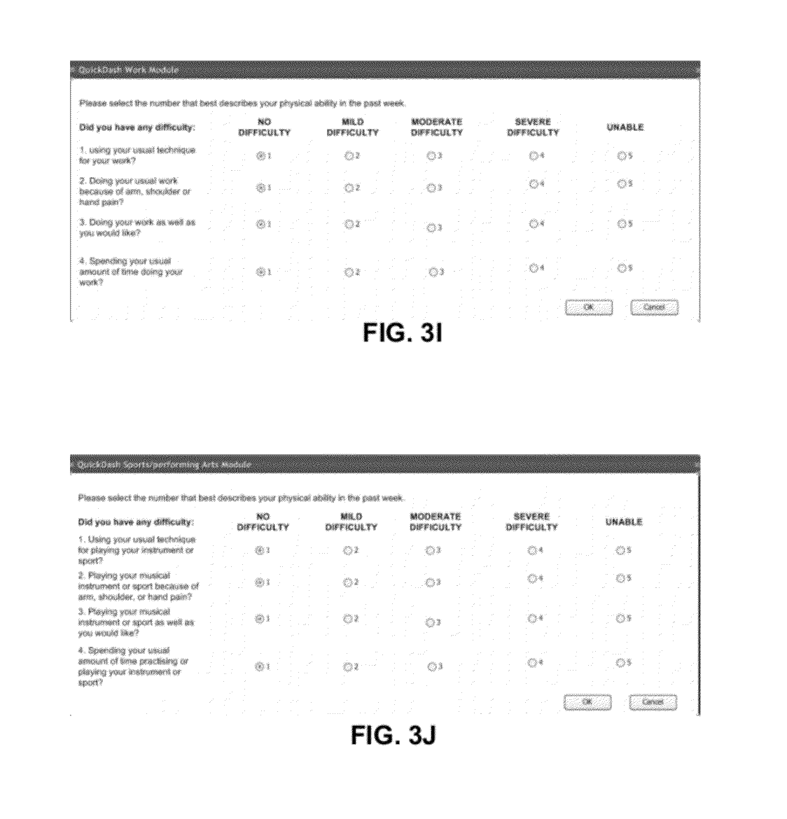

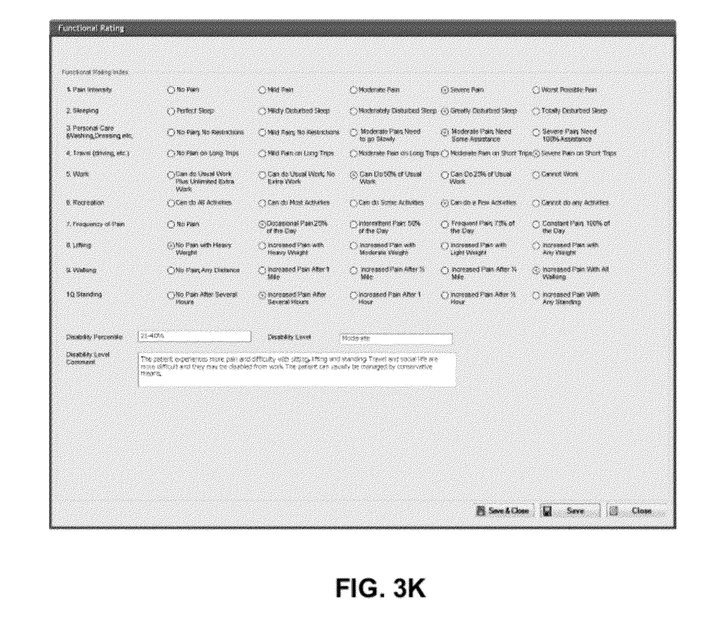

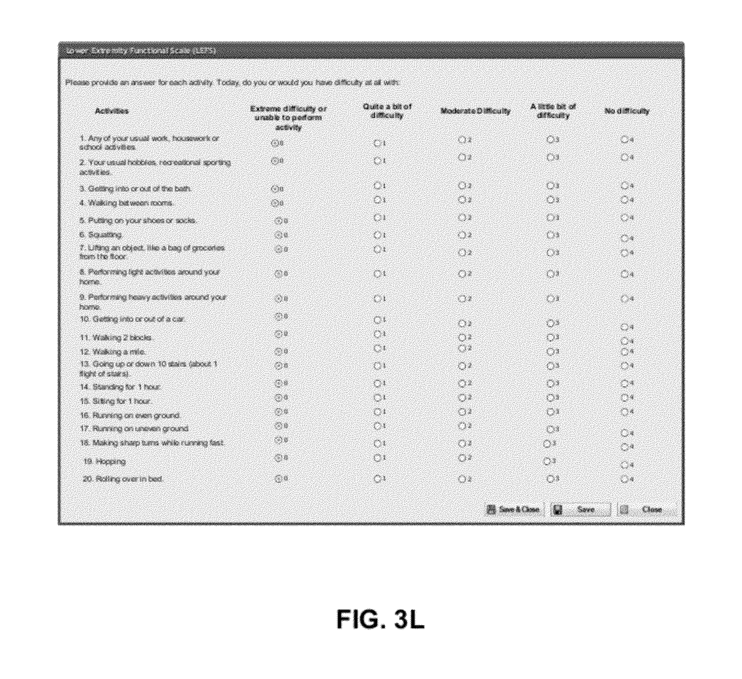

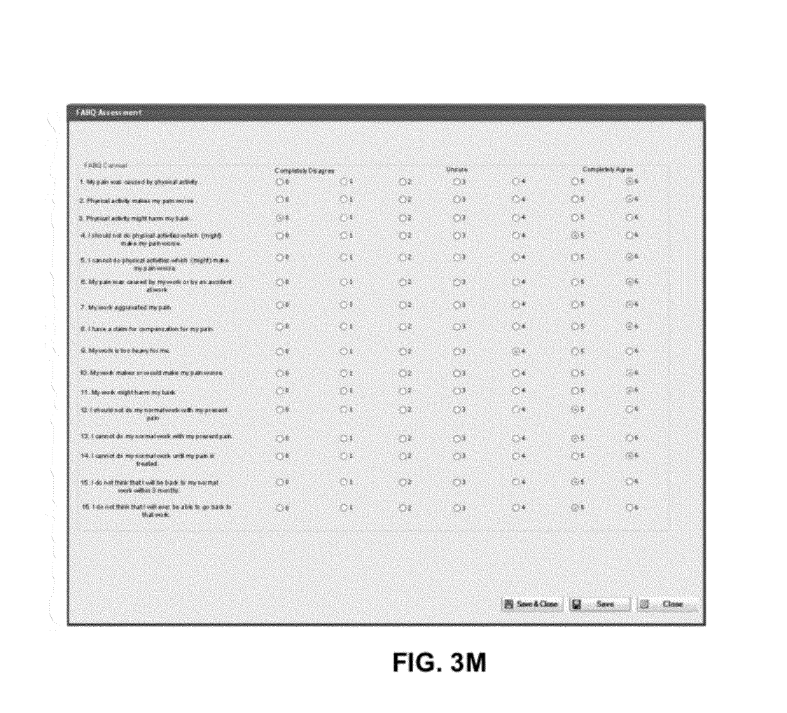

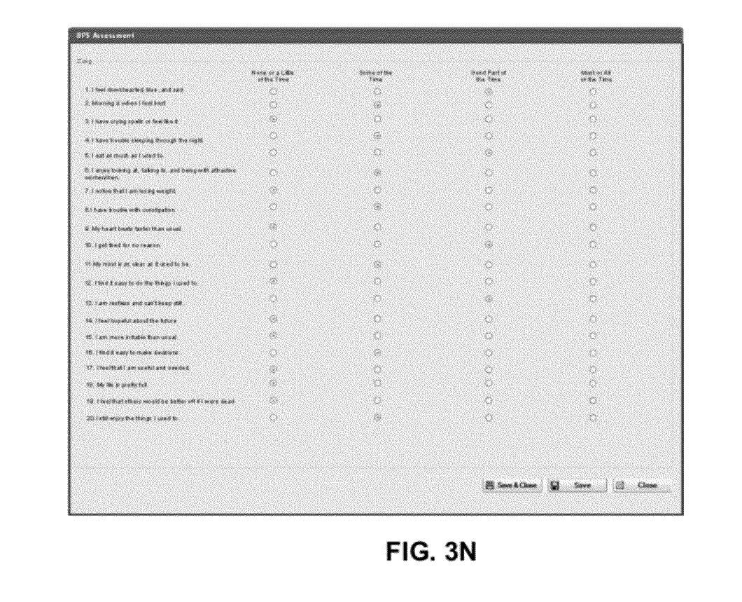

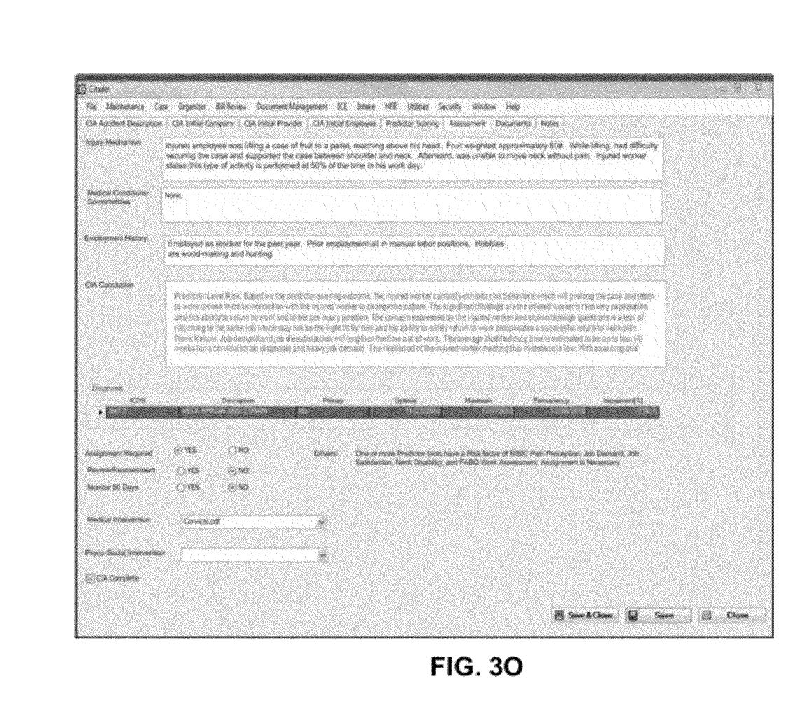

The methods described above with respect to FIGS. 2A through 2F are illustrated as screenshots in FIGS. 3A through 3O. In some embodiments, the interfaces as depicted by FIGS. 3A to 3O are displayed by the client agent 180 and any information received may be collected by the client agent 180. In some embodiments, the client agent 180 saves a copy of the records generated by using the data received in local data storage. In some embodiments, the client agent 180 may save a copy of the records in local data storage and transmit a copy to the data storage 196 of the CIA server 106.

Referring now to FIG. 3A, an example embodiment of an Accident Description Tab is depicted. The Accident Description Tab initiates the comprehensive initial assessment. As described in connection with FIG. 2A, a user may import or manually enter data related to a client or patient and their identified injury. In some embodiments, the Accident Description tab must be complete prior to navigating to any other tab. In some embodiments, the other tabs of the system are grayed out and inaccessible until a user enters the minimum required data for a client or a patient. In some embodiments, the contents of the Accident Description tab will update per claim update. In the event the Accident Description tab becomes unavailable to the user, the information within the dialog, as displayed, will update. In some embodiments, the user may enter some data and save the record. The save action initiated by the user may trigger the client agent 180 to transmit the entered data to a CIA server 106. In some embodiments, the client agent 180 may save the entered data locally on the client computing device 102 until all the required data is entered. Once all the required data is entered, the client agent may transmit the data to the CIA server 106.

In some embodiments, the may receive and display case information, such as the account code, carrier case ID (which in some embodiments, may be a number associated with a healthcare plan or other type of insurance plan), assignment to a user, and other related data. In some embodiments, the Accident Description tab may collect and display data related to the employer, which ma include the facility name, address, contact information, location, and other associated information. In some embodiment, the Accident Description tab may display employee information, such as the patient's name patient ID, gender, marital status, hire date, birth date, duration of employment, job title, and address. In some embodiments, the Accident Description tab may collect and display data related to the accident or cause of injury, such as the injury date, part of the body affected, cause of the injury, accident description, treating facility and contact information for the facility, treatment type, symptoms, and description of treatment. In some embodiments, the Accident Description tab may collect and display data related to the CIA protocol to be used in association with the patient. The Accident Description tab may provide options to Save & Close the tab, Save, or Close the tab.

Now referring to FIG. 3B, an example embodiment of the Initial Company tab is depicted. As described in relation to FIG. 2C, the Initial Company tab may collect and display data related to the client or patient's employer, such as a phone number and contact of the company, a history of the injury (i.e. whether the injury occurred at the workplace), employment data, such as duration, job title, job demand, employment status, and any concurrent employment. In some embodiments, the data may include Employer concerns and whether they were verbalized to the employee. In some embodiments, the data includes data related to the treatment provided, such as the type of treatment, how the provider was selected, and notes related to any pending, requested, or provided treatments. In some embodiments, the data may include the work status of the employee.

The data collected via the Initial Company tab may be later used to calculate a predictor score by the predictor score generator 192 of the CIA server 106. In some embodiments, for example, if the Job Demand is designated as Heavy or Very Heavy, then the system may categorize the patient as ‘RISK’ and will assign the JOB DEMAND category as RISK in the Predictor Scoring tab. If the JOB DEMAND is designated as SEDENTARY or LIGHT, then the system may categorize the patient as NORMAL and will assign the JOB DEMAND category as NORMAL in the Predictor Scoring tab. If the JOB DEMAND is designated as MEDIUM, then the system may categorize the patient as AT RISK and will assign the JOB DEMAND category as AT RISK in the Predictor Scoring tab.

Now referring to FIG. 3C, an example embodiment of an Initial Provider tab is depicted. As described in connection with FIG. 2C, an Initial Provider form 258c may collect different types of information. The collected data may include contact information for the client or patient, records of previous visits, schedule of future visits, diagnosis of the client or patient and descriptions and notes of the treatment provided, requested, or pending.

Now referring to FIG. 3D, an example embodiment of an Initial Employee form 258a is depicted. In some embodiments, the Initial Employee form may collect different types of information. In some embodiments, the Initial Employee form may collect a telephone number of the client or patient, name of the client or patient, the chief complaint of the client or patient and the mechanism or area of injury. The form may also include questions related to the employee's perception of injury on return-to-work (RTW), whether the employee displays catastrophic thinking, such as suicidal thoughts, or thoughts that may severely impair the ability of the client or patient, and the employee's perception of any employment concerns. In some embodiments, the form may include work status, record of last visit, schedule of future visit, notes of treatment that has been provided, pending, or requested and a pain assessment. In some embodiments, the form may include information regarding the client or patient's current employment (contact, position, description of job, duration, and supervisor) and past employment.

In some embodiments, if the data received via the Initial Employee form 258a indicates that the pain is out of proportion to the diagnosis or reported injury, then a red flag may be displayed and the category PAIN LEVEL will be assigned as RISK in the Predictor Scoring tab. In some embodiments, if the employee perception of injury on RTW is set to YES then the red flag may be displayed. If the employee Perception of Any Employment Concerns is set to YES, then the red flag may be displayed. If the employee displays Catastrophic thinking, then a red flag should be displayed on the form. If any of the questions of the Initial Employee form 258a is set to YES, then the category will be assigned RISK in the Predictor Scoring tab under JOB SATISFACTION. If all the questions of the form are set to NO, then under JOB SATISFACTION of the Predictor Scoring tab will be assigned NORMAL.

Now referring to FIG. 3E, an example embodiment of a Predictor Scoring Tab is depicted. In some embodiments, the Predictor Scoring tab will be at least partially complete responsive to the CIA Initial forms completed by the user. In some embodiments, the Predictor Scoring tab will list the Specialty Assessments available given the type of injury and Predictor Scoring. In some embodiments, the tab will also display standard assessments as well as an indication of whether the assessments were completed.

In the Predictor Scoring portion of the Predictor Scoring tab, if one or more Predictor tools are set to RISK then the Outcome is set to RISK. If three or more Predictor tools are set to AT RISK and 0 set to RISK then Outcome is assigned RISK. If one or two Predictor tools set to AT RISK and 0 set to RISK then Outcome is assigned AT RISK. If all Predictor tools are set to NORMAL then Outcome is assigned NORMAL.

Now referring to FIG. 3F, an example embodiment of a Neck Disability Tab is depicted. In some embodiments, the Neck Disability Tab is a collection of scales to determine various situations and activities that cause neck pain. For example, in the displayed embodiment, each group depicted contains five varying levels and descriptions for a given category. For example:
Pain Intensity
I have no pain at the moment=0
The pain is mild at the moment=1
The pain comes and goes and is moderate=2
The pain is moderate and does not vary much=3
The pain is severe but comes and goes=4
The pain is severe and does not vary much=5
   The scores should be added up and, for example, the following would apply. For scores ranging between 0-14, the Neck Disability section of the Predictor Scoring tab will be assigned NORMAL. For scores ranging between 15-25, the Neck Disability section of the Predictor Scoring tab will be assigned AT RISK. For scores ranging between 25-50, the Neck Disability section of the Predictor Scoring tab will be assigned RISK.

Now referring to FIG. 3G, an example embodiment of a Roland-Morris Tab is depicted. The user will only select the questions that are ‘TRUE’ or ‘YES’. Each selection represents 1 point. All points should be added to get a total. For scores ranging between 0-4, the Roland-Morris section of the Predictor Scoring tab will be assigned NORMAL. For scores ranging between 5-9, the Roland-Morris section of the Predictor Scoring tab will be assigned AT RISK. For scores ranging between 10-18, the Roland-Morris section of the Predictor Scoring tab will be assigned RISK.

Now referring to FIG. 3H, an example embodiment of a Quick-Dash Tab is depicted. For scoring of the Quick-Dash tab, the following equation is utilized:

$$= ( [ \frac{sum of n responses}{n} ] - 1 ) \times 25 , \\ where n is equal to the number of completed responses . \vert$$

Scores ranging between 0-40% are assigned NORMAL. Scores ranging between 41-60% are assigned AT RISK. Scores ranging between 61-100% are assigned RISK. The Quick-Dash tab may also include a Work Module. The Quick-Dash module may also include a Sports/Performing Arts module.

Now referring to FIG. 3I, an example embodiment of the Work Module is depicted. If the user selects Work Module from the Quick-Dash tab, the Work Module form is displayed. In some embodiments, at least one option must be selected per question in order to complete the assessment. To score the Work Module, the assigned values for each response are added; divided by the number of items; subtract 1; and multiply by 25. Scores ranging between 0-40% are assigned NORMAL. Scores ranging between 41-60% are assigned AT RISK. Scores ranging between 61-100% are assigned RISK.

Now referring to FIG. 3J, an example embodiment of the Sports/Performing Arts Module is depicted. If the user selects Sports/Performing Arts Module from the Quick-Dash tab, the Sports/Performing Arts Module form is displayed. In some embodiments, at least one option must be selected per question in order to complete the assessment. To score the Sports/Performing Arts Module, the assigned values for each response are added; divided by the number of items; subtract 1; and multiply by 25. Scores ranging between 0-40% are assigned NORMAL. Scores ranging between 41-60% are assigned AT RISK. Scores ranging between 61-100% are assigned RISK.

Now referring to FIG. 3K, an example embodiment of the Functional Rating tab is depicted. The scoring for the Functional Rating tab is as follows:

| Question | Answer 1 | Answer 2 | Answer 3 | Answer 4 | Answer 5 |
|---|---|---|---|---|---|
| Pain Intensity | 0 = No | 1 = Mild | 2 = Moderate | 3 Severe | 4 = Worst |
| | Pain | Pain | Paine | pain | possible pain |
| Sleeping | 0 = Perfect | 1 = Mildly | 2 = Moderately | 3 = Greatly | 4 = Totally |
| | sleep | disturbed sleep | disturbed sleep | disturbed sleep | disturbed sleep |
| Personal Care | 0 = No | 1 = Mild | 2 = Moderate | 3 = Moderate | 4 = Severe |
| (Washing, Dressing, | pain; no | pain; no | pain; need to | pain; need | pain; need |
| etc) | restrictions | restrictions | go slowly | some assistance | 100% assistance |
| Travel (driving, etc.) | 0 = No | 1 = mild | 2 = Moderate | 3 = Moderate | 4 = Severe |
| | pain on | pain on | pain on | pain on | pain on |
| | long trips | long trips | long trips | short trips | short trips |
| Work | 0 = Can do | 1 = can do | 2 = Can do | 3 = Can do | 4 = Cannot |
| | usually work | usual work; | 50% of | 25% of usual | work. |
| | plus unlimited | no extra | usually work | work | |
| | extra work | work | | | |
| Recreation | 0 = Can do | 1 = can do | 2 = can do | 3 = can do | 4 = cannot do |
| | all activities | most activities | some activities | a few activities | any activities |
| Frequency of Pain | 0 = No | 1 = Occasional | 2 = Intermittent | 3 = Frequent | 4 = Constant |
| | pain | pain; 25% of | pain; 50% of | pain; 75% of | pain 100% of |
| | | the day | the day | the day | the day |
| Lifting | 0 = No | 1 = Increased | 2 = Increased | 3 = Increased | 4 = Increased |
| | pain with | pain with | pain with | pain with | pain with |
| | heavy lifting | heavy weight | moderate weight | light weight | any weight |
| Walking | 0 = No | 1 = Increased | 2 = Increased | 3 = Increased | 4 = Increased |
| | pain any | pain after | pain after | pain after | pain with |
| | distance | 1 mile | ½ mile | ¼ mile | all walking |
| Standing | 0 = No | 1 = Increased | 2 = Increased | 3 = Increased | 4 = Increased |
| | pain after | pain after | pain after | pain after | pain with |
| | several hours | several hours | 1 hour | ½ hour | any standing |

Scoring may be attained by adding all the points for the findings. To determine the disability as a percentage, the total score is divided by 50 and then multiplied by 100. If the score ranges between 0-20% the disability percentage is assigned Minimal. Such a categorization indicates the patient can cope with most living activities. Usually no treatment is indicated apart from advice on lifting sitting and exercise. If the score ranges between 21-40%, the disability percentage is assigned Moderate. Such a categorization indicates the patient experiences more pain and difficult with sitting lifting and standing. Travel and social life are most difficult and they may be disabled from work. The patient can usually be managed by conservative means. If the score ranges between 41-60%, the disability percentage is assigned Severe. Such a categorization indicates that the pain remains the main problem in this group but activities of daily living are affected. These patients often require a detailed investigation. If the score ranges between 61-80% the disability percentage is assigned Crippled. This categorization indicates that the pain impinges on all aspects of the patient's life. Positive intervention is usually required. If the score ranges between 81-100% the disability percentage is assigned Bed Bound, which indicates the need to exclude exaggeration or malingering. In some embodiments, a disability of Minimal is assigned NORMAL, a disability of Moderate is assigned AT RISK, and a disability of Severe, Crippled, or Bed Bound is assigned RISK.

Now referring to FIG. 3L, an example embodiment of a Lower Extremity Functional Scale (LEFS) tab is depicted. The LEFS score is the sum of all the answers (for example, 1-20 in the depicted diagram). The percentage is calculated as the LEFS score divided by 80 and multiplied by 100. If the percentage ranges between 0-40% the category is assigned RISK; if the score ranges between 41-60% the category is assigned AT RISK; and if the score ranges between 61-80% the category is assigned NORMAL.

Now referring to FIG. 3M, an example embodiment of a FABQ tab is depicted. The scoring is determined by adding the values of the responses for each category. For example, question 2-5 are FABQ Physical Activity questions. The values of the questions are added and if the sum ranges between 0-11 the category is assigned NORMAL; if the sum ranges between 12-19, the category is assigned AT RISK; and if the sum ranges between 20-24, the category is assigned RISK. Questions 6, 7, 9, 10, 11, 12, 15 are FABQ Work questions. The values of the questions are added and if the sum ranges between 0-14 the category is assigned NORMAL; if the sum ranges between 15-28, the category is assigned AT RISK; and if the sum ranges between 29-42 the category is assigned RISK

Now referring to FIG. 3N, an example embodiment of the BPS Assessment is depicted. The scoring for the BPS Assessment tab is as follows:

| | None or | | Good | Most |
|---|---|---|---|---|
| | little | Some | Part | or All |
| | of the | of the | of the | of the |
| Question | Time | Time | Time | Time |
| I feel downhearted, blue, and sad | 1 | 2 | 3 | 4 |
| Morning is when I feel best | 4 | 3 | 2 | 1 |
| I have crying spells or feel like it | 1 | 2 | 3 | 4 |
| I have trouble sleeping through the | 1 | 2 | 3 | 4 |
| night | | | | |
| I eat as much as I used to | 4 | 3 | 2 | 1 |
| I enjoy looking at, talking to, and | 4 | 3 | 2 | 1 |
| being with attractive people | | | | |
| I notice that I am losing weight | 1 | 2 | 3 | 4 |
| I have trouble with constipation | 1 | 2 | 3 | 4 |
| My heart beats faster than usual | 1 | 2 | 3 | 4 |
| I get tired for no reason | 1 | 2 | 3 | 4 |
| My mind I as clear as it used to be | 4 | 3 | 2 | 1 |
| I find it easy to do the things I | 4 | 3 | 2 | 1 |
| used to | | | | |
| I am restless and can't keep still | 1 | 2 | 3 | 4 |
| I feel hopeful about the future | 4 | 3 | 2 | 1 |
| I am more irritable than usual | 1 | 2 | 3 | 4 |
| I find it easy to make decisions. | 4 | 3 | 2 | 1 |
| I feel that I am useful and needed | 4 | 3 | 2 | 1 |
| My life is pretty full | 4 | 3 | 2 | 1 |
| I feel that others would be better | 1 | 2 | 3 | 4 |
| off if I were dead | | | | |
| I still enjoy the things I used to. | 4 | 3 | 2 | 1 |

If the sum of the values of the questions is less than 50, then the category is assigned NORMAL. If the sum ranges between 50-59, then the category is assigned AT RISK. If the sum is greater or equal 70, then the category is assigned RISK. In some embodiments, if the user selects the BPS assessment, a validation check may also be included to ensure the assessment has not been completed. If the BPS assessment has been completed, then a Secondary Assessment cannot be completed. The BPS Assessment should include the Carrier Case ID and Injured Worker First and Last Name. The BPS Assessment should include a print function to allow the user to print the assessment. The BPS Assessment should include an email function to allow the user to email the assessment. The BPS Assessment should include a Generate Score button. In some embodiments, the outcome is displayed within the BPS Assessment. In some embodiments, the Secondary Results to the CIA Predictor Scoring Tab are stored. The initial CIA outcome should NOT be recalculated. In the event a Secondary Outcome is generated, generate a STUD note within the Notes tab to add the Secondary Score to the record of the client or patient.

Now referring to FIG. 3O, an example embodiment of an Assessment tab is depicted. If there is one or more tools set to RISK (Red highlight) within the Predictor Score tab then the case is assigned. The patient's record is designated so that there is no review or reassessment and no monitoring for 90 days. If there are more than 3 tools set to AT RISK (yellow highlight) and all the rest are set to NORMAL (green highlight) then the patient's record is designated so that there is no review or reassessment and no monitoring for 90 days. If there are two or less tools set to AT RISK (yellow highlight) and all the rest are set to NORMAL (green highlight) then the case is not assigned but is designated for review or reassessment. It is also designated not be monitored for 90 days. If all tools are set to NORMAL (green highlight) it is only designated to be monitored for 90 days and will not be assigned or reviewed.

The systems and methods of the CIA tool use a predictive scoring methodology to determine, calculate or generate a predictive risk score or outcome of a case based on one or more standard assessments, one or more specialty or condition specific assessments and/or one or more user or tool specified assessments. The CIA tool may use a combination of specialty assessments, including but not limited to neck disability assessment, Roland Morris assessment, quick dash assessment, functional rating assessment and/or LEPS (Loss of Earning Power) assessment to determine a predictive risk score. The CIA tool may use a combination of standard assessments to determine the predictive risk score, such as the FABQ and BPS assessments. The CIA tool may use a combination of biopsychosocial (BPS) assessments to determine the predictive risk score. The biopsychosocial model (abbreviated “BPS”) is a model or approach that posits that biological, psychological (which entails thoughts, emotions, and behaviors), and social factors, all play a significant role in human functioning in the context of disease or illness. In the BPS model, health may be understood in terms of a combination of biological, psychological, and social factors rather than purely in biological terms. The biopsychosocial (BPS) assessments may include assessing and identifying a score for pain perception, job demand and/or job satisfaction.

For each type of assessment of Biopsychosocial, specialty and standard, a score range, score, risk factor and secondary risk factor may be provided, determined or received as input from a user of the CIA tool and/or automatically generated by the CIA tool. The CIA tool may use any one or combination of the score range, score, risk factor and/or secondary risk factor to determine a single outcome predictor. The CIA tool may apply any function or algorithm to any one or combination of the score range, score, risk factor and/or secondary risk factor to determine a single outcome predictor. The CIA tool may apply a weight to any one or combination of the score range, score, risk factor and/or secondary risk factor to determine a single outcome predictor.

The CIA tool may weight the Biopsychosocial scores (e.g., pain perception, job demand, job satisfaction) differently than the scores for specialty and standard assessments. The CIA tool may use the Biopsychosocial scores (e.g., pain perception, job demand, job satisfaction) to up weight or down weight any of the specialty and standard assessment scores. The tool CIA may use the Biopsychosocial scores (e.g., pain perception, job demand, job satisfaction) to up weight or down weight any single score (e.g. an intermediate predictive score) from the combination of the specialty and standard assessment scores. In some embodiments, the pain perception, job demand, job satisfaction assessment are tool or user specified assessments. The CIA tool may support the user configuring or identify a plurality of user specific assessments, including any non-specialty and non-standard assessments.

The CIA tool may use any statistical processing of any of the standard assessment scores, specific assessment score and/or Biopsychosocial assessment score to generate, create or identify a single outcome risk predictor. The CIA tool may use any statistical processing of any of the standard assessment scores, specific assessment score and/or user specified assessment scores generate, create or identify a single outcome risk predictor.

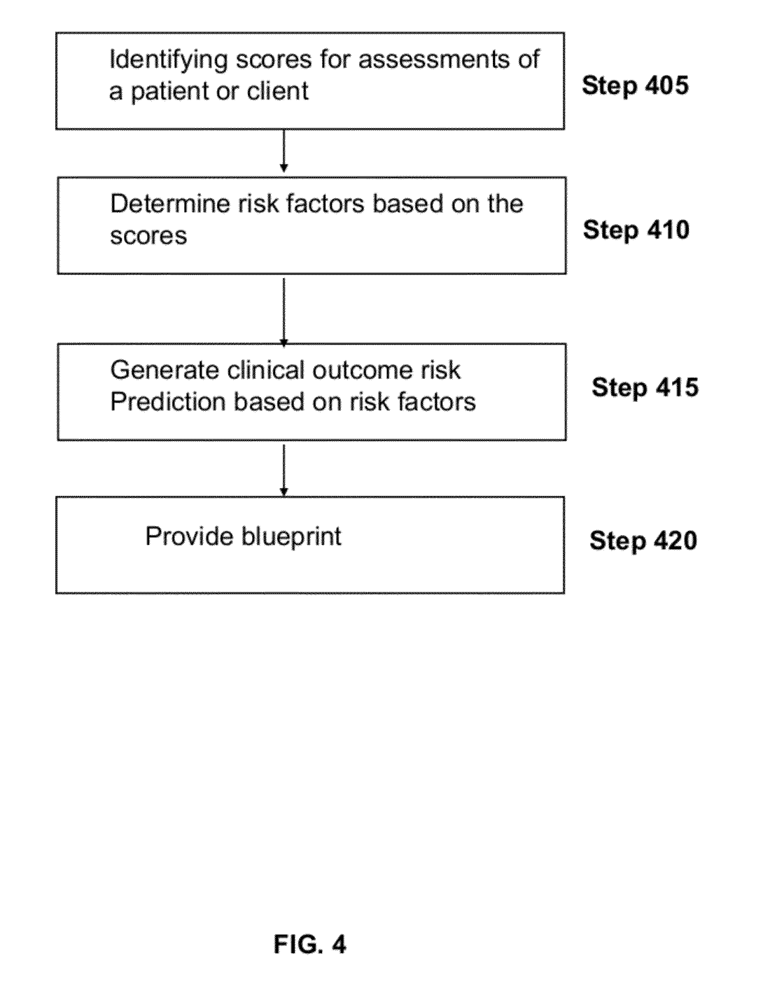

Referring now to FIG. 4, an embodiment of a method for generating an outcome risk using embodiments of the systems and CIA tool described herein is depicted. In brief overview, at step 405, the CIA tool identifies scores from different assessments given to a client or patient, such as in connection with a worker's compensation claim. At step 410, the CIA tool determines risk factors for each of the assessments based on the scores. At step 415, the CIA tool generates an outcome risk based on the risk factors. At step 420, the CIA tool provides a blueprint for the assessment which may identify timelines and risks associated with the case/claim.

In further details, at step 405, a different assessments may be performed, given or taken by a patient or client, such as an injured patent in connection with a worker's compensation claim. Any type of case manager, clinician, nurse, doctor or health care provider may perform or provide an assessment of the patient. Any type and form of assessment may be used, including standard, specialty and custom assessments. The assessment tool or test, generally referred to as an assessment, may include specialty assessment such as those identified in FIG. 3E. The assessment may comprise a standard Fear Avoidance Benefits Questionnaire (FABQ) assessment and/or a standard Behavioral Pain Score (BPS) assessment and a biopsychosocial assessment. In some embodiments, the assessment include a biopsychosocial assessment which may include one or more of the following assessments: pain perception, job demand and job satisfaction.

The tool, such as embodiments of the CIA tool, may provide a selectable list of assessments to give, take or perform for the client or patient. The tool may provide instructions for each selected assessment. The tool may provide forms for each selected assessment. The forms may include information and data to collect for the assessment. The tool may provide a user interface and/or graphical based form to collect information and data from execution of the assessment.

Based on the information and data collected for an assessment, the tool may identify, generate or calculate a score for the assessment. The score may be based on or in accordance with the scoring guidelines or instructions specified by the assessment. In some embodiments, the tool may automatically identify the score. In some embodiments, a user may enter the score into the tool. The score may be a single score. The score may be a range of scores, The score may a Yes or No indicator. The score may be a pass or fail indicator. The score may be a threshold or level indicator, such as Low, Medium or High. The score may be an average of scores of repeated assessment. The score may be an average or aggregated score of a plurality of different assessments.

At step 410, the tool determines and assigns a risk factor for each of the assessments. The tool may automatically determine and assign a risk factor, such as Risk, At Risk or Normal to each assessment based on the score identified for the assessment. A user may determine and assigning, via the tool, the risk factor. In some embodiments, the user may override, modify or confirm the risk factor automatically determined and assigned by the tool. In some embodiments, the tool skips determining risk factors for an assessment. In some embodiments, the tool determines that the score or data for an assessment is not complete, is invalid or otherwise not sufficient to determine and assign a risk factor.

Although at times, the risk factors of Risk, At Risk and Normal may be described herein, the risk factor may comprise any type and form of risk indicators on a scale with any level of granularity. The risk factor, for example, may comprise No Risk, Low Risk, Medium Risk and/or High Risk. The risk factor may be on a numerical scale, such as 1 though 5, 1 through 10 or 1 through 100.

In some embodiments, the risk factor for one assessment is based on the score and/or risk factor from a different assessment(s). In some embodiments, the tool determines the risk factor based on any data entered or received by the tool, such as any of the data received via the user interface embodiments of FIG. 3A-3O. In some embodiments, the tool determines the risk factor based on information about the patient or client, such as the type of injury, the type of work, geography, age, gender, etc. in combination with the score(s) of an assessment.

At step 415, the tool, such as via the predictive scorer, may generate an outcome risk predictor. The tool may generate the outcome risk predictor as each risk factor is determined and/or assigned to an assessment. The tool may generate the outcome risk predictor responsive to selection of a user interface element of the tool, such as a button. The tool may generate or provide the outcome risk predictor on request or demand such as via an API query. The tool may display the outcome risk predictor on the user interface of the tool. The tool may generate and output the outcome risk predictor to a file, a database or via a report.

The outcome risk predictor may be an indicator or identifier of the risk of the clinical outcome of the case under management, such as the risk to having a successful medical outcome or the patient returning to work (RTW), such as within a predetermined time period. The outcome risk predictor may comprise any embodiments of the risk factors. In some embodiments, the outcome risk predictor may comprise a scale of risk different from the scale used for the risk factors for each assessment. The outcome risk may be a numerical scale of 1 to 5, 1 to 10 or 1 to 100. The outcome risk may be No Risk, Low Risk, Med Risk and/or High Risk. An outcome risk may be assigned to each date of a plurality of dates on a timeline in which the case is being managed and/or for the worker to return to work.

In some embodiments, the outcome risk predictor identifies whether or not the outcome of the case will be successful. In some embodiments, the outcome risk predictor identifies whether or not the patient or client will return to work. In some embodiments, the outcome risk predictor identifies a timeline for completion of the case, for the patient to recover from the injury and/or estimated time to return-to-work.

The predictive scorer may generate or calculate the outcome risk based on any combination of the risk factors. The predictive scorer may generate or calculate the outcome risk based on applying a weight to each of the assessment's risk factors. The predictive scorer may generate or calculate the outcome risk based on applying a weight to a group of assessment risk factors. The predictive scorer may generate or calculate the outcome risk based on one or more biopsyhcosocial risk factors. The predictive scorer may generate or calculate the outcome risk based on one or more biopsyhcosocial risk factors in combination with risk factors from one or more standard tests, such as FASB or BSP tests. The predictive scorer may generate or calculate the outcome risk based on one or more biopsyhcosocial risk factors in combination with any specialty assessments' risk factors.

At step 420, the tool may generate, display, provide or output a blueprint of the comprehensive assessment, including any risk factors and outcome predictors. A user of the tool may enter text, upload or attach files that form part or all of the blueprint. The blueprint may comprise a medical intervention blueprint, which describes information, guidelines, treatments, physical therapy, medical treatment, progression milestones, etc for the medical intervention of the worker's injury. In some embodiments, the blueprint may comprise a Psycho-Social Intervention blueprint which describes information, guidelines, treatments, progression milestones, etc for the psychological and social intervention of the worker's injury and return to work plans. The blueprint may include any guidelines, interventions and/or recommendations for managing the risk identified by the risk factors and outcome predictor. The blueprint may include any basis, data or factors used as input to generate the outcome predictor and/or risk factors. The blueprint may identify and describe milestones for managing the case and associated risk. The blueprint may identify and describe milestones for determining the progression of the patient to return-to-work.

The methods and systems described herein may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While these methods and systems have been shown and described with reference to specific preferred embodiments, it should be understood by those skilled in the art that various changes in form and detail may be made therein.

What is claimed:

1. A method for generating a clinical outcome risk of a worker's compensation claim, the method comprising:
(a) identifying, via a tool executing on a device, a score for each of a plurality of assessments performed on a patient in connection with a worker's compensation claim of the patient;
(b) determining, via the tool, a risk factor for each score of each of the plurality of assessments; and
(c) generating, by the tool based on the determination, an outcome risk for a clinical outcome of the worker's compensation claim.

2. The method of claim 1, wherein step (a) further comprises identifying a single score for an assessment of the plurality of assessments that provides a range of scores.

3. The method of claim 1, wherein step (a) further comprises identifying the score for the plurality of assessments comprising two or more of the following: a specialty assessment, a standard Fear Avoidance Benefits Questionnaire (FABQ) assessment, a standard Behavioral Pain Score (BPS) assessment and a biopsychosocial assessment.

4. The method of claim 1, wherein step (a) further comprising identifying one or more scores for a biopsychosocial assessment comprising one or more of the following assessments: pain perception, job demand and job satisfaction.

5. The method of claim 1, wherein step (b) further comprises determining, by the tool, the risk factor for an assessment of the plurality of assessments based on the score resulting from performance of the assessment of the patient being below or above a predetermined threshold.

6. The method of claim 1, wherein step (b) further comprises determining, by the tool, the risk factor comprising one of the following: risk, at risk and normal.

7. The method of claim 1, wherein step (c) further comprises generating, by the tool, the outcome risk based on a combination of risk factors corresponding to each score of the plurality of assessments.

8. The method of claim 1, wherein step (c) further comprises generating, by the tool, the outcome risk comprising a single outcome predictor of the worker's compensation claim.

9. The method of claim 1, further comprising generating a blueprint comprising a summary of an overall assessment and at least one of the following: medical related progression and return-to-work (RTW) progression.

10. The method of claim 1, further comprising generating a blueprint comprising one of a medical intervention blueprint or a biopsychosocial blueprint.

11. A system for generating a clinical outcome risk of a worker's compensation claim, the system comprising:
a tool executing on a device identifying a score for each of a plurality of assessments performed on a patient in connection with a worker's compensation claim of the patient;
a predictive scorer of the tool determines a risk factor for each score of each of the plurality of assessments and generating, based on the determination, an outcome risk for a clinical outcome of the worker's compensation claim.

12. The system of claim 11, wherein the tool identifies a single score for an assessment of the plurality of assessments that provides a range of scores.

13. The system of claim 11, wherein the tool identifies the score for the plurality of assessments comprising two or more of the following: a specialty assessment, a standard Fear Avoidance Benefits Questionnaire (FABQ) assessment, a standard Behavioral Pain Score (BPS) assessment and a biopsychosocial assessment.

14. The system of claim 11, where the tool identifies one or more scores for a biopsychosocial assessment comprising one or more of the following assessments: pain perception, job demand and job satisfaction.

15. The system of claim 11, wherein the predictive scorer determines the risk factor for an assessment of the plurality of assessments based on the score resulting from performance of the assessment of the patient being below or above a predetermined threshold.

16. The system of claim 11, wherein the predictive scorer determines the risk factor comprising one of the following: risk, at risk and normal.

17. The system of claim 11, wherein the predictive scorer generates the outcome risk based on a combination of risk factors corresponding to each score of the plurality of assessments.

18. The system of claim 11, wherein the predictive scorer generates the outcome risk comprising a single outcome predictor of the worker's compensation claim.

19. The system of claim 11, wherein the tool generates a blueprint comprising a summary of an overall assessment and at least one of the following: medical related progression and return-to-work (RTW) progression.

20. The system of claim 11, wherein the tool generates a blueprint comprising one of a medical intervention blueprint or a biopsychosocial blueprint.
